(19) United States
(12) Patent Application Publication
(10) Pub. No.: US 2026/0247223 A1
(43) Pub. Date: Aug. 20, 2026

(54) CONTEXT TRANSFER AND DATA CONTINUITY IN WI-FI ROAMING

(71) Applicant: Nokia Technologies Oy, Espoo (FI)

(72) Inventor: Petri Kalevi KOSKELAINEN, Sunnyvale, CA (US)

(21) Appl. No.: 19/058,717

(22) Filed: Feb. 20, 2025

(51) Int. Cl. H04W 36/00; H04W 12/084; H04W 76/15

(52) U.S. Cl. CPC H04W 36/0038; H04W 12/084; H04W 76/15

(57) ABSTRACT

An apparatus, method, and computer program product are provided for exchanging information with a first access point, AP; receiving seamless roaming capability information, SRCI from a second AP; in response to determining compatibility with the second AP for roaming based at least in part on the SRCI, transmitting at least a seamless roaming request to the second AP; causing a roaming token to be provided to the second AP in association with the seamless roaming request; and performing roaming to the second AP based on a response received from the second AP.

### TECHNOLOGICAL FIELD

Various example embodiments relate generally to wireless communication networks such as Wi-Fi in which roaming between access points (APs) may be employed.

### BACKGROUND

Some applications of wireless technology rely on efficient roaming arrangements. For example, a communications system comprising a wireless local access network (WLAN) may rely on maintaining quality of service (QoS) and low latency data exchange between access points (APs) and stations (STAs), particularly as STAs move between coverage areas of APs.

### BRIEF SUMMARY

An apparatus, method and computer program product are provided for performing roaming.

According to an aspect of the present disclosure, there is provided an apparatus including at least one processor and at least one memory storing instructions that, when executed by the at least one processor, cause the apparatus to perform at least: exchanging information with a first access point, AP; receiving seamless roaming capability information, SRCI, from a second AP; in response to determining compatibility with the second AP for roaming based at least in part on the SRCI, transmitting at least a seamless roaming request to the second AP; causing a roaming token to be provided to the second AP in association with the seamless roaming request; and performing roaming to the second AP based on a response received from the second AP.

According to some embodiments, the roaming token includes one or more context transfer parameters for performing roaming to the second AP. In this embodiment, the one or more context transfer parameters include at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

According to some embodiments, the roaming token includes a remote token identifier. In this embodiment, the remote token identifier is configured to enable the second AP to receive one or more context transfer parameters or data frames from a remote source, and the remote token identifier is allocated, created, or signed by at least one of the first AP, the second AP, a seamless roaming server, SRS, or a station, STA. The remote source of some embodiments is the first AP, a third AP, a SRS, or a STA.

According to some embodiments, the roaming token further includes context information including at least one of SN or Block Ack parameters. In this embodiment, the apparatus is also caused to perform exchanging information with the second AP using at least one of the SN or Block Ack parameters.

According to some embodiments, the SRCI includes seamless roaming related information associated with at least one of: capability information associated with the second AP supporting roaming, current or supported multi-link devices, MLDs, or mobility domains, roaming agreements, SRS support, buffer information, a roaming token, downlink, DL, or uplink, UL, frame delivery, supported seamless roaming levels or configurations, multi-AP transmission opportunity, TXOP, sharing, or non-primary channel access, NPCA, information.

According to some embodiments, performing roaming includes at least one of: receiving information about adding the second AP to a first AP MLD, adding the second AP to a first AP MLD based on received information about adding the second AP to the first AP MLD, receiving information about multi-link, ML, reconfiguration with the second AP, performing ML reconfiguration with the second AP based on received information about ML reconfiguration, adding one or more links to the second AP in a first AP MLD, adding a new link to the second AP as a second AP MLD and aggregating links in a first AP MLD and the second AP MLD, or exchanging information with the second AP using a second AP MLD. The first AP and the second AP of some embodiments are able to be placed at separate locations. The seamless roaming request of some embodiments is included in an action frame, (re)association request, multi-link-operation, MLO, update request frame, ML link reconfiguration request frame, or trigger frame.

The apparatus of some embodiments is also caused to perform receiving information on at least one AP candidate from the first AP, where compatibility with the at least one AP candidate for roaming has been confirmed by the first AP; providing a link setup request to the first AP, the link setup request including information related to link addition or enablement at the at least one AP candidate; and causing the first AP to provide one or more context transfer parameters to the at least one AP candidate.

According to some embodiments, the response received from the second AP includes NPCA control information or the response received from the second AP is an NPCA control frame including NPCA control information. In this embodiment, performing roaming includes: triggering NPCA channel switching based on the received NPCA control information from the second AP; or accessing an NPCA primary or non-primary channel based on the received NPCA control information from the second AP; or switching between an NPCA channel with the first AP and an NPCA channel with the second AP based on the received NPCA control information from the second AP; or switching between an NPCA primary channel with the first AP and an NPCA non-primary channel with the second AP based on the received NPCA control information from the second AP; or switching between an NPCA non-primary channel with the first AP and a BSS primary channel with the second AP; or simultaneously accessing an NPCA channel with the first AP and an NPCA channel with the second AP based on the received NPCA control information from the second AP; or enabling an NPCA mode based on the received NPCA control information from the second AP.

The apparatus of some embodiments is also caused to perform providing roaming control parameters to the first AP or the second AP. In this embodiment, the roaming control parameters include control information associated with at least one of: an UL or DL frame delivery option associated with the roaming; an outside the context of a BSS, OCB, data frame delivery option associated with seamless roaming; a level of allowed sharing of context transfer parameters or data frames between network entities; or a selected link configuration for communication with the second AP based on link configuration information included within the SRCI.

According to another aspect of the present disclosure, there is provided a method including: exchanging information with a first access point, AP; receiving seamless roaming capability information, SRCI, from a second AP; in response to determining compatibility with the second AP for roaming based at least in part on the SRCI, transmitting at least a seamless roaming request to the second AP; causing a roaming token to be provided to the second AP in association with the seamless roaming request; and performing roaming to the second AP based on a response received from the second AP.

According to some embodiments, the roaming token includes one or more context transfer parameters for performing roaming to the second AP. In this embodiment, the one or more context transfer parameters include at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

According to some embodiments, the roaming token includes a remote token identifier. In this embodiment, the remote token identifier is configured to enable the second AP to receive one or more context transfer parameters or data frames from a remote source, and the remote token identifier is allocated, created, or signed by at least one of the first AP, the second AP, a seamless roaming server, SRS, or a station, STA. The remote source of some embodiments is the first AP, a third AP, a SRS, or a STA.

According to some embodiments, the roaming token further includes context information including at least one of SN or Block Ack parameters. In this embodiment, the method further includes exchanging information with the second AP using at least one of the SN or Block Ack parameters.

According to some embodiments, the SRCI includes seamless roaming related information associated with at least one of: capability information associated with the second AP supporting roaming, current or supported multi-link devices, MLDs, or mobility domains, roaming agreements, SRS support, buffer information, a roaming token, downlink, DL, or uplink, UL, frame delivery, supported seamless roaming levels or configurations, multi-AP transmission opportunity, TXOP, sharing, or non-primary channel access, NPCA, information.

According to some embodiments, performing roaming includes at least one of: receiving information about adding the second AP to a first AP MLD, adding the second AP to a first AP MLD based on received information about adding the second AP to the first AP MLD, receiving information about multi-link, ML, reconfiguration with the second AP, performing ML reconfiguration with the second AP based on received information about ML reconfiguration, adding one or more links to the second AP in a first AP MLD, adding a new link to the second AP as a second AP MLD and aggregating links in a first AP MLD and the second AP MLD, or exchanging information with the second AP using a second AP MLD. The first AP and the second AP of some embodiments are able to be placed at separate locations. The seamless roaming request of some embodiments is included in an action frame, (re)association request, multi-link-operation, MLO, update request frame, ML link reconfiguration request frame, or trigger frame.

The method of some embodiments further includes receiving information on at least one AP candidate from the first AP, where compatibility with the at least one AP candidate for roaming has been confirmed by the first AP; providing a link setup request to the first AP, the link setup request including information related to link addition or enablement at the at least one AP candidate; and causing the first AP to provide one or more context transfer parameters to the at least one AP candidate.

According to some embodiments, the response received from the second AP includes NPCA control information or the response received from the second AP is an NPCA control frame including NPCA control information. In this embodiment, performing roaming includes: triggering NPCA channel switching based on the received NPCA control information from the second AP; or accessing an NPCA primary or non-primary channel based on the received NPCA control information from the second AP; or switching between an NPCA channel with the first AP and an NPCA channel with the second AP based on the received NPCA control information from the second AP; or switching between an NPCA primary channel with the first AP and an NPCA non-primary channel with the second AP based on the received NPCA control information from the second AP; or switching between an NPCA non-primary channel with the first AP and a BSS primary channel with the second AP; or simultaneously accessing an NPCA channel with the first AP and an NPCA channel with the second AP based on the received NPCA control information from the second AP; or enabling an NPCA mode based on the received NPCA control information from the second AP.

The method of some embodiments further includes providing roaming control parameters to the first AP or the second AP. In this embodiment, the roaming control parameters include control information associated with at least one of: an UL or DL frame delivery option associated with the roaming; an outside the context of a BSS, OCB, data frame delivery option associated with seamless roaming; a level of allowed sharing of context transfer parameters or data frames between network entities; or a selected link configuration for communication with the second AP based on link configuration information included within the SRCI.

According to another aspect of the present disclosure, there is provided a computer program product, including at least one non-transitory computer-readable storage medium having computer-executable program code portions stored therein with the computer-executable program code portions comprising program code instructions configured to: exchange information with a first access point, AP; receive seamless roaming capability information, SRCI, from a second AP; in response to determining compatibility with the second AP for roaming based at least in part on the SRCI, transmit at least a seamless roaming request to the second AP; cause a roaming token to be provided to the second AP in association with the seamless roaming request; and perform roaming to the second AP based on a response received from the second AP.

According to some embodiments, the roaming token includes one or more context transfer parameters for performing roaming to the second AP. In this embodiment, the one or more context transfer parameters include at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

According to some embodiments, the roaming token includes a remote token identifier. In this embodiment, the remote token identifier is configured to enable the second AP to receive one or more context transfer parameters or data frames from a remote source, and the remote token identifier is allocated, created, or signed by at least one of the first AP, the second AP, a seamless roaming server, SRS, or a station, STA. The remote source of some embodiments is the first AP, a third AP, a SRS, or a STA.

According to some embodiments, the roaming token further includes context information including at least one of SN or Block Ack parameters. In this embodiment, the computer-executable program code portions include program code instructions configured to exchange information with the second AP using at least one of the SN or Block Ack parameters.

According to some embodiments, the SRCI includes seamless roaming related information associated with at least one of: capability information associated with the second AP supporting roaming, current or supported multi-link devices, MLDs, or mobility domains, roaming agreements, SRS support, buffer information, a roaming token, downlink, DL, or uplink, UL, frame delivery, supported seamless roaming levels or configurations, multi-AP transmission opportunity, TXOP, sharing, or non-primary channel access, NPCA, information.

According to some embodiments, performing roaming includes at least one of: receiving information about adding the second AP to a first AP MLD, adding the second AP to a first AP MLD based on received information about adding the second AP to the first AP MLD, receiving information about multi-link, ML, reconfiguration with the second AP, performing ML reconfiguration with the second AP based on received information about ML reconfiguration, adding one or more links to the second AP in a first AP MLD, adding a new link to the second AP as a second AP MLD and aggregating links in a first AP MLD and the second AP MLD, or exchanging information with the second AP using a second AP MLD. The first AP and the second AP of some embodiments are able to be placed at separate locations. The seamless roaming request of some embodiments is included in an action frame, (re)association request, multi-link-operation, MLO, update request frame, ML link reconfiguration request frame, or trigger frame.

According to some embodiments, the computer-executable program code portions include program code instructions configured to receive information on at least one AP candidate from the first AP, where compatibility with the at least one AP candidate for roaming has been confirmed by the first AP; provide a link setup request to the first AP, the link setup request including information related to link addition or enablement at the at least one AP candidate; and cause the first AP to provide one or more context transfer parameters to the at least one AP candidate.

According to some embodiments, the response received from the second AP includes NPCA control information or the response received from the second AP is an NPCA control frame including NPCA control information. In this embodiment, performing roaming includes: triggering NPCA channel switching based on the received NPCA control information from the second AP; or accessing an NPCA primary or non-primary channel based on the received NPCA control information from the second AP; or switching between an NPCA channel with the first AP and an NPCA channel with the second AP based on the received NPCA control information from the second AP; or switching between an NPCA primary channel with the first AP and an NPCA non-primary channel with the second AP based on the received NPCA control information from the second AP; or switching between an NPCA non-primary channel with the first AP and a BSS primary channel with the second AP; or simultaneously accessing an NPCA channel with the first AP and an NPCA channel with the second AP based on the received NPCA control information from the second AP; or enabling an NPCA mode based on the received NPCA control information from the second AP.

According to some embodiments, the computer-executable program code portions include program code instructions configured to provide roaming control parameters to the first AP or the second AP. In this embodiment, the roaming control parameters include control information associated with at least one of: an UL or DL frame delivery option associated with the roaming; an outside the context of a BSS, OCB, data frame delivery option associated with seamless roaming; a level of allowed sharing of context transfer parameters or data frames between network entities; or a selected link configuration for communication with the second AP based on link configuration information included within the SRCI.

According to another aspect of the present disclosure, there is provided an apparatus, including means for: exchanging information with a first access point, AP; receiving seamless roaming capability information, SRCI, from a second AP; in response to determining compatibility with the second AP for roaming based at least in part on the SRCI, transmitting at least a seamless roaming request to the second AP; causing a roaming token to be provided to the second AP in association with the seamless roaming request; and performing roaming to the second AP based on a response received from the second AP.

According to some embodiments, the roaming token includes one or more context transfer parameters for performing roaming to the second AP. In this embodiment, the one or more context transfer parameters include at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

According to some embodiments, the roaming token includes a remote token identifier. In this embodiment, the remote token identifier is configured to enable the second AP to receive one or more context transfer parameters or data frames from a remote source, and the remote token identifier is allocated, created, or signed by at least one of the first AP, the second AP, a seamless roaming server, SRS, or a station, STA. The remote source of some embodiments is the first AP, a third AP, a SRS, or a STA.

According to some embodiments, the roaming token further includes context information including at least one of SN or Block Ack parameters. In this embodiment, the apparatus further includes means for exchanging information with the second AP using at least one of the SN or Block Ack parameters.

According to some embodiments, the SRCI includes seamless roaming related information associated with at least one of: capability information associated with the second AP supporting roaming, current or supported multi-link devices, MLDs, or mobility domains, roaming agreements, SRS support, buffer information, a roaming token, downlink, DL, or uplink, UL, frame delivery, supported seamless roaming levels or configurations, multi-AP transmission opportunity, TXOP, sharing, or non-primary channel access, NPCA, information.

According to some embodiments, performing roaming includes at least one of: receiving information about adding the second AP to a first AP MLD, adding the second AP to a first AP MLD based on received information about adding the second AP to the first AP MLD, receiving information about multi-link, ML, reconfiguration with the second AP, performing ML reconfiguration with the second AP based on received information about ML reconfiguration, adding one or more links to the second AP in a first AP MLD, adding a new link to the second AP as a second AP MLD and aggregating links in a first AP MLD and the second AP MLD, or exchanging information with the second AP using a second AP MLD. The first AP and the second AP of some embodiments are able to be placed at separate locations. The seamless roaming request of some embodiments is included in an action frame, (re)association request, multi-link-operation, MLO, update request frame, ML link reconfiguration request frame, or trigger frame.

The apparatus of some embodiments also includes means for receiving information on at least one AP candidate from the first AP, where compatibility with the at least one AP candidate for roaming has been confirmed by the first AP; providing a link setup request to the first AP, the link setup request including information related to link addition or enablement at the at least one AP candidate; and causing the first AP to provide one or more context transfer parameters to the at least one AP candidate.

According to some embodiments, the response received from the second AP includes NPCA control information or the response received from the second AP is an NPCA control frame including NPCA control information. In this embodiment, performing roaming includes: triggering NPCA channel switching based on the received NPCA control information from the second AP; or accessing an NPCA primary or non-primary channel based on the received NPCA control information from the second AP; or switching between an NPCA channel with the first AP and an NPCA channel with the second AP based on the received NPCA control information from the second AP; or switching between an NPCA primary channel with the first AP and an NPCA non-primary channel with the second AP based on the received NPCA control information from the second AP; or switching between an NPCA non-primary channel with the first AP and a BSS primary channel with the second AP; or simultaneously accessing an NPCA channel with the first AP and an NPCA channel with the second AP based on the received NPCA control information from the second AP; or enabling an NPCA mode based on the received NPCA control information from the second AP.

The apparatus of some embodiments also includes means for providing roaming control parameters to the first AP or the second AP. In this embodiment, the roaming control parameters include control information associated with at least one of: an UL or DL frame delivery option associated with the roaming; an outside the context of a BSS, OCB, data frame delivery option associated with seamless roaming; a level of allowed sharing of context transfer parameters or data frames between network entities; or a selected link configuration for communication with the second AP based on link configuration information included within the SRCI.

According to another aspect of the present disclosure, there is provided an apparatus including at least one processor and at least one memory storing instructions that, when executed by the at least one processor, cause the apparatus to perform at least: transmitting seamless roaming capability information, SRCI; receiving a seamless roaming request associated with a station, STA; determining compatibility with the STA for roaming based on the seamless roaming request; receiving, based on the compatibility determination and in association with the seamless roaming request, a roaming token; and performing roaming with the STA based at least in part on the roaming token.

According to some embodiments, the roaming token includes (i) one or more context transfer parameters for performing roaming with the STA or (ii) a remote token identifier configured to enable receiving one or more context transfer parameters for performing roaming with the STA. In this embodiment, the roaming token is received from at least one of the STA, an access point, AP, a seamless roaming server, or an SRS.

According to some embodiments, the one or more context transfer parameters include at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

According to some embodiments, the roaming token further includes context information including at least one of SN or Block Ack parameters. In this embodiment, the apparatus is also caused to perform exchanging information with the STA using at least one of the SN or Block Ack parameters.

According to another aspect of the present disclosure, there is provided a method including: transmitting seamless roaming capability information, SRCI; receiving a seamless roaming request associated with a station, STA; determining compatibility with the STA for roaming based on the seamless roaming request; receiving, based on the compatibility determination and in association with the seamless roaming request, a roaming token; and performing roaming with the STA based at least in part on the roaming token.

According to some embodiments, the roaming token includes (i) one or more context transfer parameters for performing roaming with the STA or (ii) a remote token identifier configured to enable receiving one or more context transfer parameters for performing roaming with the STA. In this embodiment, the roaming token is received from at least one of the STA, an access point, AP, a seamless roaming server, or an SRS.

According to some embodiments, the one or more context transfer parameters include at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

According to some embodiments, the roaming token further includes context information including at least one of SN or Block Ack parameters. In this embodiment, the method further includes exchanging information with the STA using at least one of the SN or Block Ack parameters.

According to another aspect of the present disclosure, there is provided a computer program product, including at least one non-transitory computer-readable storage medium having computer-executable program code portions stored therein with the computer-executable program code portions comprising program code instructions configured to: transmit seamless roaming capability information, SRCI; receive a seamless roaming request associated with a station, STA; determine compatibility with the STA for roaming based on the seamless roaming request; receive, based on the compatibility determination and in association with the seamless roaming request, a roaming token; and perform roaming with the STA based at least in part on the roaming token.

According to some embodiments, the roaming token includes (i) one or more context transfer parameters for performing roaming with the STA or (ii) a remote token identifier configured to enable receiving one or more context transfer parameters for performing roaming with the STA. In this embodiment, the roaming token is received from at least one of the STA, an access point, AP, a seamless roaming server, or an SRS.

According to some embodiments, the one or more context transfer parameters include at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

According to some embodiments, the roaming token further includes context information including at least one of SN or Block Ack parameters. In this embodiment, the computer-executable program code portions include program code instructions configured to exchange information with the STA using at least one of the SN or Block Ack parameters.

According to another aspect of the present disclosure, there is provided an apparatus, including means for: transmitting seamless roaming capability information, SRCI; receiving a seamless roaming request associated with a station, STA; determining compatibility with the STA for roaming based on the seamless roaming request; receiving, based on the compatibility determination and in association with the seamless roaming request, a roaming token; and performing roaming with the STA based at least in part on the roaming token.

According to some embodiments, the roaming token includes (i) one or more context transfer parameters for performing roaming with the STA or (ii) a remote token identifier configured to enable receiving one or more context transfer parameters for performing roaming with the STA. In this embodiment, the roaming token is received from at least one of the STA, an access point, AP, a seamless roaming server, or an SRS.

According to some embodiments, the one or more context transfer parameters include at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

According to some embodiments, the roaming token further includes context information including at least one of SN or Block Ack parameters. In this embodiment, the apparatus also includes means for exchanging information with the STA using at least one of the SN or Block Ack parameters.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a diagram of an example communication system in accordance with some example embodiments;

FIG. 2 is a diagram of an example communication system in accordance with some example embodiments;

FIG. 3 is a diagram of an example communication system in accordance with some example embodiments;

FIG. 4 is a diagram of an example of signaling in a communication system in accordance with some example embodiments;

FIG. 5 illustrates an example of seamless roaming capability information (SRCI) in accordance with some embodiments described herein;

FIG. 6 illustrates an example seamless roaming request in accordance with some embodiments described herein;

FIG. 7 illustrates an example roaming token in accordance with some embodiments described herein;

FIG. 8 illustrates the operations performed, such as by the apparatus of FIG. 10, in accordance with at least an example embodiment;

FIG. 9 illustrates the operations performed, such as by the apparatus of FIG. 10, in accordance with at least an example embodiment; and

FIG. 10 is a block diagram of an apparatus that may be specifically configured in accordance with an example embodiment of the present disclosure.

### DETAILED DESCRIPTION

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

Certain embodiments described may be implemented in a communications system (e.g., a communication network), such as any of the following radio access technologies (RATs): wireless fidelity (Wi-Fi), BLUETOOTH, Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunications system (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future radio access technology (RAT) such as 6G. Moreover, communication within the communication network may utilize any suitable wireless communication technology, comprising but not limited to:

Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiplexing (OFDM), and/or Discrete Fourier Transform spread OFDM (DFT-s-OFDM).

The term “terminal device” refers to any end device that may be capable of wireless communication. By way of example, a terminal device may be referred to as a communication device, user equipment (UE), a Subscriber Station (SS), a Mobile Station (MS). The terminal device may include a mobile phone, a cellular phone, a smart phone, voice over IP (VoIP) phones, wireless local loop phones, a tablet, a wearable terminal device, a personal digital assistant (PDA), portable computers, desktop computers, image capture terminal devices such as digital cameras, gaming terminal devices, music storage and playback appliances, vehicle-mounted wireless terminal devices, universal serial bus (USB) USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

A term “resource”, as used herein, may refer to radio resources in time domain, in frequency domain, in space domain, and/or in code domain. Some examples of resources include e.g. a physical resource block (PRB), a radio frame, a subframe, a time slot, a subband, a frequency region, a sub-carrier, a beam, etc. The term “transmission” and/or “reception” may refer to wirelessly transmitting and/or receiving respectively via a wireless propagation channel on radio resources.

In some examples, a communications system may be deployed in a wireless local area network (WLAN), such as a Wi-Fi network. That is, in some examples, a communications system may be an example of a WLAN system. The WLAN system may support wireless communications between one or more communications devices in accordance with one or more Wi-Fi protocols, such as protocols based on institute of electrical and electronics engineers (IEEE) 802.11 standards and/or related drafts, such as 802.11-2020, 802.11ac, 802.11ax, 802.11be, 802.11bn, and/or others.

In some examples, Wi-Fi communications may occur via one or more radio frequency bands, such as 2.4 gigahertz (GHz), 3.6 GHz, 5 GHz, 6 GHz, 60 GHz, and/or the like. In some such examples, each radio frequency band may support one or more channels (e.g., 20 megahertz (MHz) channels) over which data may be communicated. In some examples, multiple devices may use multiple channels to communicate over the WLAN simultaneously.

A WLAN system may include one or more communications devices, such as an access point (AP) and/or a station (STA), which is also referred to herein as a non-AP STA. For example, a device configured to support one or more Wi-Fi protocols may be an example of an AP (e.g., may operate in accordance with an AP mode) and/or may be an example of a non-AP STA (e.g., may operate in accordance with a non-AP STA mode). In some examples, an AP may control Wi-Fi communications for one or more non-AP STAs. For example, an AP may be (or may be connected to) a central entity used to establish (and/or control) one or more connections between one or more STAs and another network (e.g., the Internet). In other words, in some examples, the AP may connect a wired network (e.g., the Internet) to a wireless network (e.g., the WLAN). In some instances, a Wi-Fi network may be identified via one or more identifiers, such as a service set identifier (SSID) or a basic service set identifier (BSSID).

In some examples, an AP of a WLAN system includes at least one distribution system access function configured to facilitate data communication beyond the AP. Additionally, or alternatively, STAs may be configured to be end devices, which rely on association with an AP to communicate with devices other than the AP. An AP may be configured to connect to a wired local area network (LAN) (e.g., via Ethernet). The AP may allow one or more client devices (e.g., STAs) to access wireless connections via WLAN. The client devices may also be referred to as “WLAN clients”. WLAN clients may comprise various devices and/or types of devices, including laptops, tablets, cell phones, and/or other devices.

A WLAN system may support one or more architectures (types of logical relationships between devices). For example, a WLAN system may support an autonomous architecture, a centralized architecture, a cooperative architecture, and/or other types of architectures. In some examples of an autonomous architecture, APs are stand-alone APs configured with features and capabilities to operate without any reliance on another device. In some examples of a centralized architecture, a centralized network manager may regulate the operation of the WLAN. In other words, the network manager may be the AP or may be connected to one or more APs within the WLAN. For example, APs may be connected (e.g., wirelessly and/or via a wired connection) to a central entity, which may be configured to act as a network manager. In some examples, the network manager is a cloud-based entity, which may reside either in a private cloud or in a public cloud. In some examples of a cooperative architecture (also referred to as a network manager-less or controller-less architecture), a virtual management (e.g., cloud-based) system may be used to control a WLAN. For example, the virtual management system may employ a cooperative communication method between one or more APs to control the WLAN. In other examples, a centralized network manager may use a wireless system to provide local connection to clients (e.g., STAs). For example, the centralized network manager may be a controller configured to perform operations related to authentication, authorization, accounting (e.g., via an authentication, authorizing, and accounting (AAA) server), and/or other operations.

Additionally, or alternatively, a WLAN system may support one or more topologies (types of physical connections between various devices within the WLAN system). For example, the WLAN system may support an infrastructure topology which may include a combination of wired and wireless connections. In some examples of an infrastructure topology, the infrastructure topology may include one or more wired devices with a wired connection to a network (e.g., one or more APs that are each connected via a cable to a switch) and the one or more wired devices may support one or more wireless connections to one or more wireless devices (e.g., laptops, tablets, cell phones), such that the wireless devices may connect wirelessly to the network. In other words, the one or more wired devices may serve as a bridge between the wireless network and the wired network. Additionally, or alternatively, the WLAN system may support an ad hoc topology, which does not rely on infrastructure (e.g., cables, routers, servers, or APs). In some examples of an ad hoc network, one or more STAs (also referred to as clients or client devices) may wirelessly connect to other devices in a peer-to-peer network. Additionally, or alternatively, the WLAN system may support a mesh topology in which multiple network devices are interconnected with each other via wireless connections. For example, in accordance with a mesh topology, an AP (e.g., each AP), which may support one or more wireless connections with one or more STAs, may communicate wirelessly with one or more other APs.

In accordance with one or more Wi-Fi protocols, data may be transmitted wirelessly between two devices (e.g., an AP and a STA) via packets, referred to as protocol data units (PDUs). In other words, Wi-Fi communications may include transmission and reception of one or more PDUs. For example, data may be communicated via a frame (e.g., a medium access control (MAC) frame), which may include one or more PDUs. In some instances, multiple frames may include the same PDU. In some examples, a PDU may include data (referred to as a payload), as well as one or more headers (e.g., a sequence of one or more fields) and/or one or more trailers (e.g., a sequence of bits appended to the PDU, after the payload). In some examples, the data included in the PDU, may be user data, control data, management data, and/or other types of data. In some examples, frames may include data type frames, control type frames, management type frames, and/or other types of frames. At least one frame type (e.g., each frame type) may be included in a PDU, wherein a payload of a PDU may comprise user data, control data, management data, and/or other data. In some examples, a WLAN system may implement one or more security protocols to protect the confidentiality, integrity, and availability of Wi-Fi communications.

In some examples, a WLAN system may support transmission opportunities (TXOPs) to increase throughput, such as for high priority data, by providing contention-free channel access for a period of time. A TXOP may be available in a quality of service (QoS) mode as part of Enhanced Distributed Channel Access (EDCA), and/or may be a limited time period of contention-free channel access available to the channel-owning station (e.g., the TXOP holder). During such a period a TXOP holder, which may be a STA or an AP, may send multiple frames that satisfy criteria, which may have been determined for the use of TXOP. In some examples, the criteria may allow transmission of frames belonging to an access category (AC) other than the AC for which the TXOP has been obtained. In some examples, a TXOP may increase throughput and/or reduce delay of QoS data frames by eliminating contention periods between transmissions. In some examples, a TXOP may be used in combination with frame aggregation and block acknowledgement to further increase throughput.

In some examples, access categories have different channel access parameters, such as Arbitration Interframe Spacing (AIFS), duration, contention window size, and TXOP limit. In some examples, values of these parameters may be set in a manner that increases a likelihood of higher priority packets being prioritized over lower priority packets. For example, the values of the parameters may be set that a STA (typically) waits for a shorter duration before sending the higher priority packets compared to a duration that the STA may wait before sending the lower priority packets. Additionally, or alternatively, the values of the parameters may be set so that the contention window for higher priority packets is smaller than that of lower priority packets and/or so that multiple packets may be sent in a TXOP. In some examples, a TXOP holder, which may be either a STA or an AP, may send frames to multiple recipients during a TXOP. In addition to QoS data frames, other frames may be exchanged during the TXOP, such as an acknowledgement (ACK), BlockAckReq/BlockAck frames, and/or other control and management frames.

In some examples, a WLAN system uses multi-link operation (MLO) to improve data transmission (e.g., via using multiple frequency bands for transmissions). In some examples, MLO further comprises various features, including simultaneous transmit and receive (STR), multi-channel multi-radio (MCMR), enhanced multi-AP roaming (E-MAR), non-simultaneous transmit and receive (NSTR), multi-link multi-radio (MLMR), and/or other features.

An AP that supports MLO may be referred to as an AP multi-link device (MLD). An MLO-capable client, for example, such as a STA, may be referred to as a non-AP MLD. Such a client device may have two or more STAs with which it may establish links to an AP MLD. A connection between a STA and AP may represent a link between an AP MLD and a non-AP MLD. In some examples, APs which do not support MLO may be multi-band APs which have two or more APs operating in different bands and/or channels. An AP may operate in one or more bands and/or channels and a client device may connect to the AP via one or more of the bands and/or channels. For example, a client device may associate with the AP in one of the channels. An AP MLD may operate as a multi-band AP, while providing means for a multi-link (ML) capable client (non-AP MLD) to simultaneously use two or more of its radios and/or APs for communication with a single association. An AP MLD may be an MLMR, which is configured to communicate simultaneously with its APs with associated non-AP MLDs. Non-AP MLDs may have constraints (e.g., NSTR), which may indicate that simultaneous communication over established links is not possible. Therefore, in some such instances, a non-AP MLD may associate to an AP MLD. Accordingly, the non-AP MLD may be associated over two or more bands and/or channels and may communicate with the APs affiliated to the AP MLD over the established links.

WLAN devices configured with STR may be configured to allow simultaneous transmission and/or reception via different respective frequency bands, which may reduce latency. WLAN devices configured with MCMR may be configured to allow data transmission via two or more radios and/or channels, which may increase efficiency, reduce congestion, and/or increase network speeds. WLAN devices configured with enhanced multilink single-radio (EMLSR) may be configured to allow client devices to switch between multiple respective APs while maintaining their connections, which may allow more consistent connectivity. WLAN devices configured with NSTR may be configured to allow client devices to non-simultaneous transmission and/or reception via different respective frequency bands, which may reduce latency (particularly in comparison with single-link operation). WLAN devices configured with MLMR may be configured to allow different respective radios and/or channels to be used for managing respective links, which may reduce interference and/or improve network performance.

A WLAN system may be configured with various types of service sets, for example, such as basic service set (BSS) and/or an extended service set (ESS). A BSS may be comprised of an AP and one or more client devices (e.g., STAs) associated with the AP. The one or more client devices may have one or more common physical layer (PHY) medium access characteristics (e.g., radio frequency, modulation scheme, security settings, and/or the like). A BSSID may define the BSS such that the one or more client devices of the BSS share the same BSSID.

In some examples, two or more BSSs may have overlapping coverage areas, and they may operate with either partially or entirely same radio frequency channels. In such examples of overlapping BSSs (OBSSs), a client device may transmit frames from the area of overlap, and one or more other client devices may sense the transmission. Responsive to sensing the transmission, the one or more other client devices may cease their own transmissions. In some examples, if the other client devices do not sense the transmission, the other client devices may become hidden terminals with respect to the client device which is transmitting.

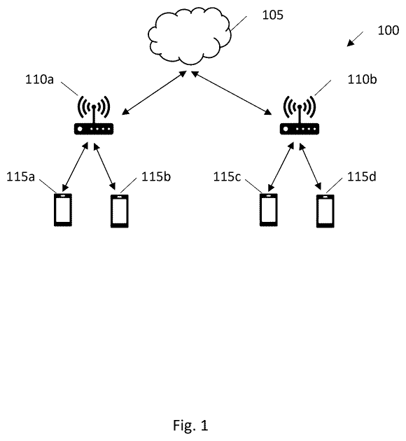

FIG. 1 illustrates an example communications system 100 to which one or more examples disclosed herein may be applied. The communications system 100 may include a cloud network 105, one or more APs (e.g., an AP 110-a, an AP 110-b), and one or more client devices, also referred to herein as STAs, connected to the one or more APs. For example, the communications system 100 may include a STA 115-a and a STA 115-b connected to the AP 110-a, as well as a STA 115-c and a STA 115-d connected to the AP 110-b. In some examples, the APs 110 may be mobile access points (mAPs) with constrained functionality. In some such examples, a configuration comprising an mAP and a STA may be implemented as part of a peer-to-peer connection, for example, as in Wi-Fi Direct or Wi-Fi Aware. In some examples, a device may simultaneously operate as a STA and as an AP. One such an example case is in a multi-AP network, which includes two or more devices that may act as APs and use Wi-Fi for the wireless backhaul connectivity based on a STA-AP connection model.

In some wireless communications systems, APs may provide wireless connectivity for one or more STAs according to the Wi-Fi standards, such as those that are a subset of the IEEE 802 family of standards. For example, the MAC and PHY specifications for Wi-Fi access points are defined by IEEE 802.11 for transmitting and receiving data in frequency bands such as 2.4 GHz, 3.6 GHz, 5 GHz, 6 GHz, 60 GHz, and/or the like. APs and STAs may communicate through the transmission of frames, including data frames, management frames, and/or control frames, which may be transmitted in unicast messages, broadcast messages, or multicast messages. The 802.11 standards define an inter-frame space (IFS) as the nominal time (in microseconds (μs)) that the MAC and PHY use to receive the last symbol of a frame, process the frame, and respond with the first symbol of a response frame (e.g., the earliest possible response frame).

In the example of FIG. 1, the STAs 115 may be configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, STAs, UEs, and/or other entities suitable for such usage. For example, the communications system 100 may support radio frequency sensing during IFS.

The communications system 100 may support latency-sensitive applications at Wi-Fi devices (e.g., APs, STAs). Some such applications may include for example virtual reality applications, mixed reality applications, extended reality (XR) and augmented reality (AR) applications. In some cases, reliability and non-deterministic channel access, such as for wideband transmissions, may constrain a performance of latency-sensitive applications. For example, for a wideband transmission (or channel bonding), a device may use a primary 20 MHz channel to communicate control frames and management frames and may communicate data frames by bonding a BSS primary channel (also referred to herein as a reference primary channel or, more simply, a primary channel) with one or more other available 20 MHz channels, which are referred to as secondary channels. Channel bonding was introduced to provide for transmissions over multiple contiguous 20 MHz channels. In some instances, channel bonding may support transmissions over a total bandwidth of 40 MHz, 80 MHz, 160 MHz, or 320 MHz.

In some examples, if the device assesses the BSS primary channel to be idle, the device may perform a wideband transmission across a bandwidth including the BSS primary channel or the BSS primary channel and one or multiple contiguous secondary channels (e.g., totaling 40 MHz, 80 MHz, or 160 MHz or 320MHz). In some instances, however, an overlapping basic service set (OBSS) transmission may overlap (partially or fully) with the BSS primary channel. In some such instances, the device may determine that the BSS primary channel is busy and, as such, may defer the wideband transmission. Consequently, the secondary channels may sit idle until the BSS primary channel is available, which may lead to reduced performance, for example, for latency-sensitive applications.

IEEE 802.11ac has defined a procedure to enable a device, such as a STA, to adjust a transmission bandwidth of the STA per TXOP to include 20 MHz, 40 MHz, 80 MHz, or 160 MHz based on channel availability. In some examples, however, the adjustment to the transmission bandwidth may be contingent upon the resulting bandwidth being contiguous, and the primary channel was assessed to be idle. For example, the STA may adjust the transmission bandwidth of the STA per TXOP to include 20 MHz, 40 MHz, 80 MHz, or 160 MHz based on channel availability so long as the resulting bandwidth is contiguous, and the primary channel was assessed to be idle. In some cases, however, such constraint may result in a substantial amount of unused spectrum, as some non-contiguous 20 MHz channels may be available, but sit idle due to the STA being constrained to using contiguous channels.

Existing Wi-Fi roaming ensures service continuity when a STA moves from the coverage area of a source or current AP to that of a target AP. If the APs belong to the same extended service set (ESS), roaming STAs may keep the higher layer connectivity (and IP address) intact. In fast roaming, such as pairwise master key (PMK) caching/802.11r, time-consuming key negotiation and authentication phase may be skipped. Wi-Fi 7 (IEEE 802.11be) introduced MLO which enables devices to simultaneously send and receive data across different frequency bands and channels. The MLO allows a ML station to switch links with minimal signaling overhead and delay, thereby enabling seamless roaming between APs under the control of the same (physical) AP MLD. An AP MLD can use ML reconfiguration to add one or more affiliated APs to the AP MLD in the same physical AP MLD. Wi-Fi 8 is expected to further improve roaming. As used herein, seamless roaming in WLANs is an approach in which associated STAs can join other, related APs and stay associated with the same or related mobility domain without any disruption in on-going QoS data flows.

However, there are several technical challenges in existing roaming solutions in WLANs. For example, AP MLD level roaming requires that the non-AP MLD (e.g., a STA) must disassociate from the current AP MLD and re-associate with a new AP MLD during the roaming process, sometime referred to herein as the transition period. This existing disassociation and re-association during the transition period requires new authentication and interrupts frame transmissions. AP MLDs are also limited to the same physical device. In some examples, connectivity may become too slow and unreliable or a STA may suddenly lose connectivity with the current AP such that the roaming process cannot be initiated via the current AP. Further, in such an example, context information (e.g., context transfer parameters) at the current AP is lost, downlink (DL) frames buffered at the current AP are inaccessible to the STA, uplink (UL) frames cannot be sent before the AP has association with the target AP, and the current AP is unable to add new or delete current links in MLO (as the connectivity to STA is lost).

In general, existing solutions may suffer from the fact that only APs can add or delete links in MLO, via ML reconfiguration. STAs cannot add or delete links, even if there is connectivity and/or a STA has knowledge of candidate target AP(s). Another technical challenge in some cases is that current and target APs cannot detect each other via radio link which means that APs cannot communicate with each other. APs being unable to communicate with each other is problematic in various examples, such as with a fast-moving STAs, power or Internet connectivity loss at the current AP, or when the APs are too far from each other.

Various example embodiments of the present disclosure address these and other technical challenges. For example, in some embodiments described herein, a STA may send a seamless roaming request and/or a roaming token directly to the target AP (instead of, or in addition to the current AP). The roaming token, in some embodiments, includes or provides access to context transfer parameters relevant for the target AP and STA. Context transfer parameters may include information needed for the target AP to resume connectivity and data transfer state (e.g. sequence numbers (SNs), buffer status, etc.) and to take over the role of the current AP (with the same parameters and without re-authentication or re-negotiation, to the extent possible).

In various embodiments, the roaming token may allow the target AP to verify a seamless roaming request and/or receive or resolve further context transfer parameters and/or receive and forward DL frames to the STA. In some embodiments, the roaming token may originate from or be signed by the target AP, current AP, or the STA. Additionally or alternatively, in some embodiments, the roaming token may originate from or be signed by a Seamless Roaming Server (SRS), which is a new network entity configured for sharing roaming information such as context transfer parameters, other data, and forwarding data frames. An SRS may be distributed and/or it may be incorporated in STAs or APs. An SRS may provide seamless roaming between separate mobility domains.

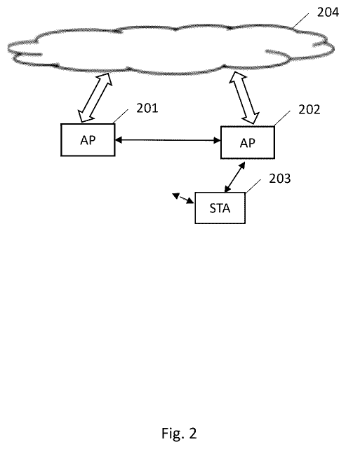

FIG. 2 illustrates an example communications system 200 to which one or more examples disclosed herein may be applied. The AP 201 and the AP 202 are non-collocated APs within the same (distributed) MLD or extended MLD. The AP 201 and the AP 202 may exchange information via radio link or via the cloud 204. In an example, the STA 203 is moving and is currently associated with the AP 201, also referred to as the current AP. Suddenly, the STA 203 may lose connectivity with the current AP 201. In such a case, the STA 203 may detect the AP 202, also referred to as the target AP. The beacon (or fast initial link setup (FILS) frames, Probe Responses or other frame types) of AP 202 may be included within seamless roaming capability information (SRCI) relating to the capability for seamless roaming of the AP 202 (and/or client-initiated link transfer). The SRCI may also include information about current or supported MLDs, mobility domains, roaming agreements, SRS support, information relating to buffer information (e.g., buffer sizes or status), multi-AP coordination, spatial re-use and/or joint transmission. In some examples, the STA 203 may know about the capabilities of the AP 202 based on an earlier configuration or information received from the AP 201. In some examples, the STA 203 may determine compatibility with the target AP 202 based on the SRCI.

After, such as immediately after, losing connectivity to the AP 201 (or even before, for example, based on received signal strength indicator (RSSI) value), the STA 203 may transmit a seamless roaming request to the target AP 202. In some examples, the seamless roaming request may include a roaming token associated with context transfer parameters. In some examples, the AP 202 may retrieve further information (e.g., context transfer parameters) from the AP 201 (e.g., via radio link or the cloud 204) if they are connected. Since the AP 202 is part of the current MLD, the AP 202 may add a new ML link and restore the association between the STA 203 and the AP 201 without authentication or re-association. The AP 202 may also retain the context transfer parameters (e.g., SNs, Block Ack Agreement details, etc.). The AP 202 may also receive DL frames from the AP 201 and forward those to the STA 203.

In certain embodiments, a roaming token may include a remote token identifier configured to enable a target AP to receive context transfer parameters and/or data frames from a remote source. For example, a remote token identifier may identify a remote source where context transfer parameters are available. In some embodiments, a roaming token may allow a STA to roam to a target AP that is not part of the current AP MLD or extended MLD. In various embodiments, target APs may also receive some of the context transfer parameters (or data frames) from an SRS. In some embodiments, during the roaming transition period, DL and/or UL frame delivery may use an outside the context of a BSS (OCB) approach which may help minimize the frame delivery delay during the transition period. In some embodiments, the 60 GHz channel may be used to share seamless roaming awareness information. In some embodiments, a STA may directly trigger the roaming process with a target AP. Further, in various embodiments, a STA may add or delete ML links with either a current AP or a target AP.

In some embodiments, the current and target AP are part of the same AP MLD. For example, the current AP 201 and the target AP 202 may be non-collocated (e.g., physically separate entities). In such an example, the current AP 201 and the target AP 202 may share the upper MAC layer that coordinates MLO (e.g., by adding or removing links in the physically separate APs 201 and 202). In various embodiments, communication between the current AP 201 and target AP 202 in the non-collocated AP MLD may use a wired or wireless seamless awareness channel connection. Action frames and/or beacons may be used in some embodiments for capability updates related to context transfer parameters between the current AP 201 and the target AP 202. Context transfer parameters or buffered DL frames at the current AP 201 may be transmitted in various embodiments to a candidate target AP (e.g., target AP 202 or another possible target AP) using unicast or group/broadcast delivery methods. In some embodiments, sharing of the context transfer parameters may be optimized based on a machine learning algorithm to avoid unnecessary sharing (traffic), for example, in a situation in which the roaming is deemed unlikely by such a machine learning algorithm.

In some embodiments, a current AP and a target AP may not be part of the same AP MLD and/or connectivity to a current AP may be suddenly lost. In such embodiments, an SRS may be beneficial as it may provide a clearinghouse to coordinate and facilitate transfer of context transfer parameters and other data, particularly within the same mobility group (seamless mobility domain). An SRS may also be used to facilitate roaming across separate seamless mobility domains. In some embodiments, a current AP and a target AP may be physically separate by having no physical or mechanical connection therebetween. In some embodiments, a current AP and a target AP may be physically separate but disposed in a common housing, such as an AP-MLD, or the current AP and target AP may be physically separate and placed in different locations.

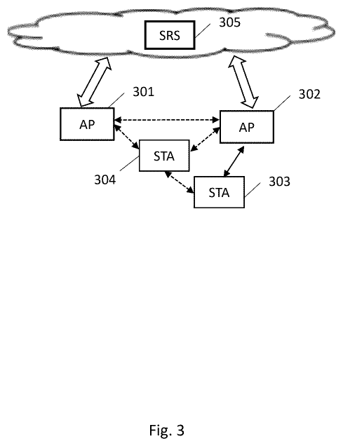

FIG. 3 illustrates an example communications system 300 to which one or more examples disclosed herein may be applied. In an example, the AP 301 and AP 302 are not part of the same MLD or extended MLD. The AP 301 and the AP 302 may reach the SRS 305 in the cloud 306 (e.g. the APs 301 and 302 may have shared some initial information or they may have an agreement with the SRS 205) and the APs 301 and 302 may optionally detect each other via radio link. Additionally or alternatively, in some embodiments, other STAs, such as STA 304 may partially or fully include the SRS 305 functionality. Similarly to the example referenced in FIG. 2, the STA 303 has lost connectivity to the AP 301 and is aware that the nearby AP 302 supports seamless roaming (e.g. based on FILS frames or beacons). Accordingly, the STA 303 may transmit a seamless roaming request to the AP 302. The seamless roaming request may include a roaming token. Based on the roaming token, the AP 302 may retrieve context transfer parameters and status information, for example, from the SRS 305 or from the AP 301 (or its MLD). DL frames may be delivered to the STA 303 via the AP 302 or via the SRS 305 or SRS-capable STA 304.

In some embodiments, the STA 303 may provide context transfer parameters to the target AP 302. In some examples, the context transfer parameters may be included or referenced within a client-initiated trigger, such as in the seamless roaming request to the target AP 302. Additionally or alternatively, in some embodiments, the STA 303 may provide the context transfer parameters before or after the seamless roaming request. In various embodiments, the target AP 302 may proceed with the roaming process based on the seamless roaming request and/or context transfer parameters from the STA 303. Additionally or alternatively, in some embodiments, the target AP 302 may receive the context transfer parameters (and/or data frames) from the current AP 301 via a radio link or via the cloud. Additionally or alternatively, in some embodiments, the target AP 302 may retrieve the context transfer parameters or other data from the SRS 305 (or multiple SRSs).

In various embodiments, an SRS may be local (e.g. within the same building) or cloud-based. In some embodiments, an SRS may be an edge device, or co-located with one or more APs. In some embodiments, some context transfer parameters (e.g., information related to the UL or DL, SNs or Block Acks, etc.) may be provided by a STA immediately when attempting to roam to a target AP, while other context transfer parameters (e.g., DL frame buffer status, etc.) may be provided by a current AP. By providing various context transfer parameters via different sources, certain example embodiments may increase efficiency and speed up the roaming process.

In some embodiments, an SRS may be a distributed SRS. For example, the functionality of a distributed SRS may be split or duplicated between plurality of APs, servers and/or STAs. In one embodiment, at least part of a distributed SRS functionality may be incorporated in STAs, such as mobile phones, computers, automotives, or IoT sensors allowing fast access to context transfer parameters for the STA or other STAs. For example, the SRS 305 may be a distributed SRS at least partially incorporated within the nearby STA 304 which may reach the current AP 301 or may itself be associated with or contain context transfer parameters relevant for the APs 301 and 302 or roaming STA 303 (e.g., information received from the AP 301 just after the roaming STA 303 lost connectivity with the current AP 301).

In some embodiments, machine learning may be utilized to configure a distributed SRS arrangement. For example, STAs moving to the same direction (e.g. in a train or users walking in the mall) may be SRS candidates for facilitating roaming, and machine learning may be used to monitor data associated with the STAs and dynamically configure a distributed SRS associated with one or more of the STAs to facilitate roaming. In various embodiments, SRSs may use 60 GHz channel for communication, or any other suitable channel.

Context transfer parameters, in some embodiments, may include MSDU-level context data, such as information related to SNs, Block Ack parameters (BA), or buffer status information. Additionally or alternatively, in some embodiments, context transfer parameters may include coordinated beamforming related information or ML information. Additionally or alternatively, in various embodiments, context transfer parameters may include authentication parameters and/or higher layer information such as transmission control protocol/internet protocol (TCP/IP) session information and/or multipath TCP (MPTCP) information, such as MPTCP SN or MPTCP Ack status information. Additionally or alternatively, in some embodiments, context transfer parameters may include geographical information, time-specific limitation or value, primary channel information, secondary channel information, target wake time (TWT) scheduling information, or spatial re-use information. Additionally or alternatively, in some embodiments, context transfer parameters may include information on a lower capability power mode (e.g. a device moving between lower and higher capability modes), or periodic unavailability periods (e.g. due to inter-device interference). In some embodiments, including such control or status information in the seamless roaming request (or response) may allow a STA to avoid at least one TXOP that would be otherwise needed for the dedicated control frame. Additionally or alternatively, in certain embodiments, context transfer parameters may include information from or otherwise associated with a current (e.g., serving) AP and/or a roaming STA.

In some embodiments, the roaming token may include context transfer parameters. Alternatively, in various embodiments, the context transfer parameters may include the roaming token. In any case, the roaming token may be unique, varying, or random in various embodiments. The roaming token may be allocated or created by a STA, a current AP, a target AP, and/or SRS. In some embodiments, a STA may provide the roaming token in advance to a current AP, to an SRS and/or other nearby APs. In various embodiments, the roaming token may be used to verify a seamless roaming request and speed up the roaming process. For example, in preparation of potential seamless roaming requests at a target AP from STAs that are associated with a current AP, the current AP MLD may have created or allocated the roaming token, and the roaming token (e.g., a hashed, shortened, or modified version of it) may be distributed to other APs, an associated STA, or the like in the area. Alternatively, in some embodiments, a target AP may create or sign the roaming token and distribute the roaming token to approved mobility domains, APs, STAs or SRSs. In various embodiments, a STA may receive the roaming token (or modified version of it) from a current AP or a target AP or from an SRS at some point before performing roaming.

In some embodiments, the roaming token (or part of it) may remain the same during processing, or it may vary. For example, the roaming token may vary periodically (e.g. every 30 seconds), based on some client-initiated trigger, or in response to information from a current AP or SRS. In some embodiments, the roaming token may vary based on the information in data frames, such as SN. The roaming token may include, in some embodiments, a signature from a STA, SRS, current AP, target AP, and/or AP MLD. Additionally or alternatively, in some embodiments, the roaming token may include any other context transfer parameters. Additionally or alternatively, in various embodiments, the roaming token may include a remote token identifier, such as an ID or universal resource indicator (URI) that allows a target AP to retrieve or resolve context transfer information (or other relevant information) from a local or remote source (e.g., an SRS, current AP, or the like). Additionally or alternatively, in some embodiments, the remote token identifier may be associated with information relating to a long-range seamless roaming channel a current AP is using.

In some embodiments, a STA may provide context transfer parameters to a current AP, a target AP, an AP MLD, and/or SRS, for example, regarding general seamless roaming preferences and/or capabilities. For example, a STA may request the level of (e.g. how aggressive) context transfer parameters and data sharing in general, or specifically in relation to a current AP, a target AP or candidate target APs, and/or SRSs. In an example, a STA that prefers security or battery optimization may request that context transfer parameter and data sharing in general is minimized or blocked prior or during the roaming. In another example, another STA may request that context transfer parameter sharing is allowed within the current non-collocated AP MLD or with AP MLDs that have seamless roaming agreement with the AP MLD or STA. In another example, a STA may request that context transfer parameter sharing is maximized (e.g., with any potential target AP or SRS that implements minimum security requirements). In various embodiments, a STA may have or be associated with different profiles or settings (e.g. a work profile, setting, mode, etc.) that may, for example, trigger different values, such as traffic to a certain (IP or MAC) destination, or cause traffic with certain traffic identifiers (TIDs) to be treated differently in roaming (e.g. minimized or maximized context transfer parameters, and/or OCB frame delivery allowed or OCB frame delivery not allowed during or before the new link has been fully configured). In some embodiments, these roaming configuration parameters may be provided in a (Re-) Association Request, in a new action frame, or the like.

In various embodiments, a target AP may retrieve and/or receive at least some or all of the context transfer parameters from a current AP or AP MLD using a separate radio link with the current AP, for example, the 2.4 GHz band, 5 GHz band, or the 60 GHz band which may provide connectivity up to 2 kilometers. For example, APs may have a separate (e.g., 60 GHz) radio for seamless roaming purposes, allowing direct transmission of context transfer parameters on the 60 GHz band between a current AP and a target AP (even if they are out of reach of each other in lower bands). In some embodiments, the 60 GHz band may also be used to deliver DL frames (e.g., buffered at a current AP) to a STA via a target AP. Additionally or alternatively, in various embodiments, the 60 GHz band may be used as a general seamless roaming awareness channel between APs, between APs and STAs, and/or between STAs.

In some example embodiments, SRCI for STAs and/or APs may be transmitted on an awareness channel based on a time interval (e.g., transmitted every 20 ms). Additionally or alternatively, in some embodiments, context transfer parameters, DL data frame delivery from a current AP to a target AP, SRCI, seamless roaming awareness information between APs, or the like may use separate channels (e.g., two or more separate 2.4 GHZ, 5 GHz, 6 GHz and/or 60 GHz channels).

In various embodiments, the roaming token may enable seamless roaming to an AP that is not part of the current AP MLD, extended MLD, or seamless mobility domain. For example, an SRS may coordinate necessary authentication and sharing of context transfer parameters to such an AP (e.g., using the remote token, the remote token identifier, roaming agreements, or the like). In some embodiments, a SRS may start receiving context transfer parameters from an AP and/or STA based on some trigger (e.g. based on a request from a STA, current AP, or target AP). In various embodiments, machine learning may be utilized to configure or optimize a SRS context parameter database (e.g., based on STA movement, direction, NPCA or channel conditions, RSSI, and/or history of the STA or other STAs in the same area in the past). For example, an SRS (or STA) may leverage machine learning to predict that STA roaming is likely (e.g., based on the movement pattern of the STA, and/or historical movement patterns of other STAs) and, in preparation of the likely roaming, the SRS may trigger the reception of context transfer parameters (and/or DL frames) from a current AP, and/or transfer to a suitable target AP(s). Machine learning may help minimize unnecessary transmissions of context transfer parameters or other data. In some embodiments, a machine learning engine may reside in an AP, AP MLD, or STA. For example, a machine learning engine in a STA may estimate that roaming is likely or possible, and then inform the SRS (or AP) what AP or parameters to utilize, based on the machine learning algorithm. In an example, the machine learning algorithm may utilize information related to a STA's or other devices' past movement history in the area, information from the other wireless devices in the area, battery information, NPCA information, channel conditions and other relevant information.

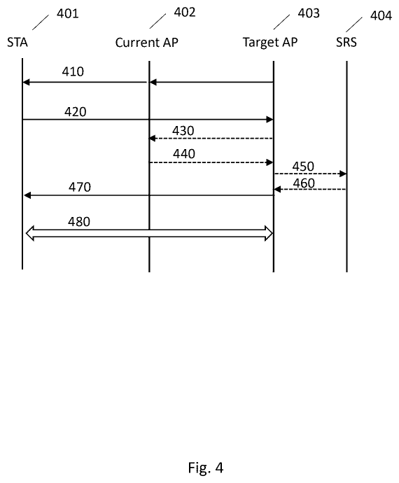

FIG. 4 illustrates an example of signaling in a communication system to which one or more examples disclosed herein may be applied. While the STA 401 is associated with the current AP 402, the STA 401 (and optionally the current AP 402) may receive the beacon 410 (or other frame) from the target AP 403. Based on the contents of the frame (e.g., SRCI), the STA 401 may determine compatibility with the target AP 403 for roaming (e.g., that the target AP 403 may perform seamless roaming for the current association the STA 401 has with the current AP 402). The STA 401 may transmit the seamless roaming request 420 to the target AP 403. The seamless roaming request 420 may include the roaming token and/or context transfer parameters. The target AP 403 may optionally retrieve (further) context transfer parameters (e.g., using the roaming token) or other data from the current AP 402 via a request 430 and receive a response 440. Additionally or alternatively, the target AP 403 may optionally request (further) context transfer parameters (e.g., using the roaming token) or other data from the SRS 404 via a request 450 and receive a response 460. The STA 401 receives a response 470 (which may be a ML reconfiguration message) confirming the successful link update. Once the target AP 403 has partially or fully restored the context, it can initiate (and/or resume) the connectivity and data exchange 480. The target AP 403 or STA 401 may use ML link reconfiguration or a similar arrangement, for example, depending on the context transfer parameters or MLD status. For example, if the current AP 402 and the target AP 403 are non-collocated APs in the same (distributed) MLD, the target AP 403 may automatically receive the full context transfer status and/or buffered DL frames. If the current AP 402 and the target AP 403 do not belong to the same MLD, they can fully or partially restore the connectivity and context status based on the roaming token from the STA 401 and/or received context transfer parameters and other information (e.g., from the current AP 402 and/or the SRS 404).

In some embodiments, SRCI may include information related to an AP's capability to support seamless roaming, current or supported MLDs or mobility domains, roaming agreements, SRS support, buffer information, and/or DL/UL frame delivery options (e.g., in general, or specifically for certain MLDs and/or TIDs). Additionally or alternatively, in some embodiments, SRCI may also include a roaming token. For example, the roaming token may be created by a target AP or AP MLD, or the target AP may receive the roaming token from a current AP, AP MLD, other APs, STAs, or SRS. In some embodiments, the roaming token may be a combination or a result of input from a target AP and a current AP. In various embodiments, SRCI may be transmitted, for example, in a beacon, FILS discovery frame, probe response frame, or the like.

In various embodiments, DL and/or UL frame delivery during roaming may use an OCB frame delivery approach. For example, an OCB DL frame delivery option allows ultra-low latency DL frame delivery, even before a STA has fully resumed or established association (or AP MLD link) with a target AP (e.g., during the transition period). For example, a candidate target AP (or SRS-supporting STA) may immediately deliver the DL frames that are buffered at a current AP (or at the SRS), even before the completion of the roaming process (e.g. before adding the affiliated AP MLD or performing ML link reconfiguration). In some embodiments, such DL frames may be proactively forwarded to a candidate target AP(s), or the candidate target AP may retrieve them immediately when the candidate target AP receives the seamless roaming request from a STA. In some embodiments, candidate target APs may use separate ultra-low latency wireless or wired connections to a current (serving) AP or AP MLD (and/or the upper MAC layer of the AP MLD). In some embodiments, such DL frames may be sent with new SN and/or Block Ack agreements, or using the existing context (e.g. the buffered DL frames may be forwarded from a current AP or SRS to the candidate target AP and existing SN and Block Acks are used as such). In various embodiments, a machine learning algorithm may be used to optimize the timing for when to start delivering the DL and context transfer parameters from a current AP (or SRS) to a target AP. In some embodiments, similar OCB arrangements may be used for UL frames.

In some embodiments, SRCI may include the information indicating support for OCB DL or UL frame delivery in general and/or specifically for certain connections (e.g. for certain TID or application flow). For example, SRCI may include one bit indicating support for seamless roaming OCB DL (SR OCB DL), and if the bit is 1, the SRCI may optionally include further data indicating SR OCB DL support for specific associations or links (e.g., association IDs or AP MLDs for which a candidate target AP has already necessary information). In some embodiments, SRCI may be transmitted, for example, in a beacon, probe response, (re)association response, FILS discovery frame, and/or the like.

In some embodiments, a STA may request SR OCB DL and UL options in the seamless roaming request, in some examples, with context transfer parameters such as temporary encryption key, suggested SN or Block Ack treatment related values, and/or the like. Additionally or alternatively, in some embodiments, the seamless roaming request may include or be associated with context transfer parameters indicating a timer interval for how long (or for how much data) DL frame delivery may continue in an OCB mode. For example, a STA may limit the time to a maximum of 500 ms or any other value (e.g., for security reasons). In various embodiments, a STA may receive similar context transfer parameters from an AP.

In some embodiments, the seamless roaming described herein may be associated with some number of pre-determined seamless roaming levels and configurations (even if not the optimal configurations). Certain example embodiments may use these configurations initially, and then later use ML reconfiguration to perform further optimization with a target AP. By doing so, certain example embodiments may benefit from allowing instant, always available, good-enough QoS link reconfiguration with a target AP. For example, a candidate target AP (or current AP) may send short target AP SRCI indicating 2-3 supported link configurations, and a STA could then pick one of the 2-3 supported link configurations in the seamless roaming request, optionally with shortened versions of dynamic context transfer parameters relating to the current association or MLD. In some embodiments, a STA may include a larger set of seamless roaming request configurations and/or context transfer parameters in the seamless roaming request.

In some embodiments, context transfer parameters or the roaming token may include information relevant for multi-AP coordination, for example, coordinated beamforming or coordinated spatial re-use information. In various embodiments, context transfer parameters may be part of multi-AP coordination information, and context transfer parameters may be part of a multi-AP coordination operation. For example, a target AP may use coordinated TDMA (C-TDMA), in which the sharing AP is sharing it's transmit opportunity (TXOP) time resource on the same channel with polled APs. In such an example, if a roaming STA holds a transmit opportunity with a current AP, then the STA may continue using the same transmit opportunities with a target AP. In some examples, a roaming STA may transmit a TXOP trigger frame to a target AP and the TXOP trigger frame may be used as a seamless roaming request, or a seamless roaming request may be used as a TXOP associated control frame in Multi-AP coordination, for example, a trigger frame in C-TDMA. In some examples, a roaming STA may indicate its low latency needs in the seamless roaming request. In some examples, including low latency needs in the initial seamless roaming request may allow the AP participating in the multi-AP coordination to take the low latency needs into account immediately (without the need to wait for response to its Multi-AP coordination message). In various embodiments, the seamless roaming request (and/or response) may be used to carry other Multi-AP coordination (e.g. C-TDMA) related control information. In various embodiments, a roaming STA may participate in and contribute to coordinated measurement in multi-AP coordination (e.g., so that the seamless roaming request or response includes information related to OBSS or so that the seamless roaming request or response may include information related to a measurement request from an AP). In some embodiments, a roaming STA may also utilize coordinated multi-AP measurements as a deciding factor to determine to which APs to try to roam.

In some embodiments, the seamless roaming request is a new action frame. Additionally or alternatively, in some embodiments, the seamless roaming request may be included as a parameter in a probe request, (re-)association request, MLO update request frame, trigger frame, or ML link reconfiguration request frame. In some embodiments, a seamless roaming response may be a new action frame or action response frame. In some embodiments, the seamless roaming response may be included in one or more of a probe response, (re-)association response, MLO update response frame, ML link reconfiguration response frame, trigger frame or in multi-AP coordination, joint transmission frame, or the like.

In some embodiments, the seamless roaming request or a roaming indication may be sent to a current AP, target AP, AP MLD, and/or SRS. In some embodiments, roaming indication may be used to inform other entities (e.g., the current AP, target AP, AP MLD, and/or SRS) about potential seamless roaming and allow such entities to prepare for it (e.g. allocating buffer capacity or retrieving information from a remote source).

In some embodiments, a STA may use different MLO methods (e.g. simultaneous or non-simultaneous modes). For example, multi-link multi radio simultaneous Tx and Rx (MLMR-STR) is an asynchronous simultaneous transmit and/or receive mode in different links at the same time. The MLMR-STR method may be used to achieve maximal throughput. In some embodiments, MLMR-STR may be operated in a non-collocated mode. This is especially useful if a STA moves back and forth between APs as it can switch links instantly (e.g. only at the first time it adds the link such as by using ML reconfiguration).

In various embodiments, seamless roaming may also be used with non-primary channel access (NPCA). One problem with wideband channels (especially 320 MHz) is that the primary 20 MHz channel must be idle in order to use the wideband channel (e.g., BSS primary channel). For this purpose, using an NPCA approach allows the use of an NPCA primary or NPCA non-primary channel (e.g., a secondary channel), for example, the remaining, idle parts of the channel, beyond the 20 MHz primary channel. For example, in addition to (or instead of) using NPCA when the primary channel is busy, a STA may initiate seamless roaming to another non-collocated AP, such that the current non-NPCA, or NPCA primary or non-primary channel access (e.g. 40 MHz) is kept active, but seamless roaming is used to add an affiliated nearby AP (or enable a disabled link) to a current AP MLD. In this manner, a STA may keep the current channel (e.g. the 40 MHz secondary channel) to a current AP while simultaneously having access to a wider bandwidth channel (e.g. 160 MHz) active on the link to a new (target) AP. In some embodiments, a STA may use a simultaneous transmit mode and/or link aggregation in these channels. In some embodiments, NPCA related control or status information may be included within the context transfer parameters that an AP, STA or SRS provides to a target AP. Such information may be used, for example, in multi-AP coordination. Additionally or alternatively, in some embodiments, NPCA related status information may be included within the SRCI so that STAs may learn about likely or suggested (secondary) channel conditions and/or parameters in advance of the seamless roaming request. Such NPCA related information in the context transfer parameters or SRCI may relate, for example, to certain channels, access methods, TID, NAV, OBSS, AID, EDCA parameters, AP MLDs, mobility group, applications or frequency bands. In some embodiments, a current AP, SRS, or target AP may provide NPCA control or status information to a STA in a seamless roaming response, SRCI or in another message associated with seamless roaming. Such NPCA control or status information may relate to a BSS in which the target AP is a member. Examples of NPCA related operations at the STA based, at least in part, on the received NPCA control or status information include, but are not limited to triggering NPCA channel switching, accessing NPCA primary or non-primary channel, switching between an NPCA channel with the current AP and an NPCA channel with the target AP, switching between an NPCA primary channel with the current AP and an NPCA non-primary channel with the target AP, switching between an NPCA non-primary channel with the current AP and BSS primary channel with the target AP, simultaneously accessing NPCA channel with the current AP and NPCA channel with the second AP, or enabling NPCA mode. In some embodiments, a STA may aggregate traffic from the NPCA and/or non-NPCA channels in a ML NPCA arrangement. The ML NPCA arrangement with the current and target AP may retain the context used in connection with the current AP (such as continue frame sequence numbers in UL frames). Additionally or alternatively, a STA may provide the NPCA control or status information to a current AP, SRS or target AP.

In some embodiments, candidate target APs may be added to a current AP MLD in advance (e.g., before a STA is in the coverage area of the candidate target APs). For example, a STA may request a current AP MLD to add a set of candidate target APs to a current AP MLD or AP. Additionally or alternatively, in some embodiments, an SRS may add such candidate target APs, for example, without request, based on the SRS's own policies, or based on suggestions by the SRS's machine learning algorithm. In various embodiments, links to such candidate target APs may be kept disabled until the roaming happens. In such a case, a STA may request link enablement from a target AP (e.g., using a link enable request) or the seamless roaming request may include request information or otherwise trigger the link enablement. In various embodiments, one or more virtual links may be used in ML setup such that the one or more virtual links are created in a disabled mode to serve as potential future links (e.g., using initial link parameters selected so that the potential like are likely work in most environments). In some embodiments, relevant ML context transfer parameters may be shared with an SRS, current AP, or target AP in real-time in preparation of potential seamless roaming. For example, a STA may have 2 links with a current physical AP MLD (e.g., one in 2.4 GHz band and another in 5 GHz band) that are in active use, and then one additional disabled virtual link (e.g., in 5 GHz band to another AP in the nearby building). In some embodiments, an SRS may receive context transfer parameters and/or data frame related information related to the MLO so that the SRS is able to support transmission of context transfer parameters to a new AP (e.g. by providing all or some of the context transfer parameters to the target AP proactively or based on a request from the target AP or STA). In such a case, the seamless roaming request may also be a ML reconfiguration related message.

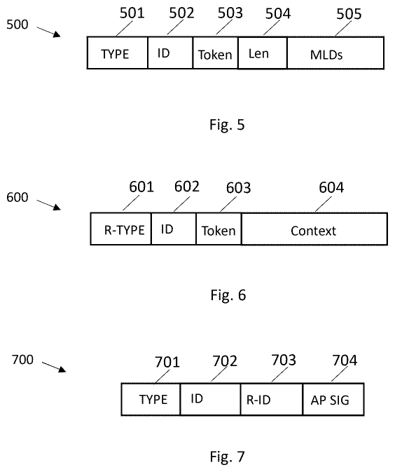

FIG. 5 illustrates an example of SRCI in accordance with some embodiments described herein. In some embodiments, the SRCI element 500 may be transmitted by an AP, for example in a beacon or FILS discovery frame. The SRCI element 500 includes the type field 501 (e.g., a seamless roaming capability element), the ID 502 (e.g., an identifier), the roaming token 503, the length 504 (e.g., the length of mobility domain fields), and the supported mobility domains 505. In some embodiments, the SRCI element 500 may include additional or alternative elements. In some embodiments, SRCI element 500 may include additional seamless roaming context capabilities that help STAs to understand which context transfer parameters may be resumed with or without re-negotiation. In some embodiments, a shortened version of the SRCI element 500 may be used. For example, a discovery frame may use a shortened 1-octed SRCI. In some embodiments, the SRCI may also re-use existing fields in the discovery or beacon frames.

FIG. 6 illustrates an example seamless roaming request in accordance with some embodiments described herein. The seamless roaming request 600 includes the request type 601 (e.g., seamless roaming between MLDs), the ID 602, the token parameters 603, and the context transfer parameters 604.

FIG. 7 illustrates an example roaming token in accordance with some embodiments described herein. The roaming token 700 includes the token type 701, the ID 702, the remote token ID 703, and the AP signature 704 (e.g., the signature of the current AP or SRS).

The various embodiments described herein may be used alone or fully or partially combined with other embodiments described herein. For example, a STA may send the roaming request to a current AP or SRS. A STA may be a user terminal device, such as mobile device or laptop. A STA may also be an in-vehicle communication module, multimedia device (such as TV), or sensor device. A STA may support communication technologies, such as cellular communication (4G, 5G, 6G, etc.), near field communication (NFC) and wireless local area networking, such as IEEE 802.11 (such as 802.11be or 802.11be), ultra-wideband (UWB) or Bluetooth.

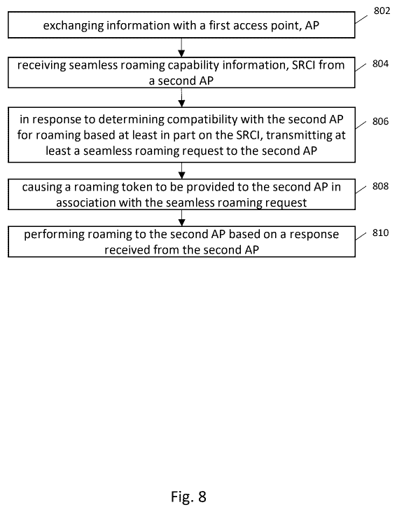

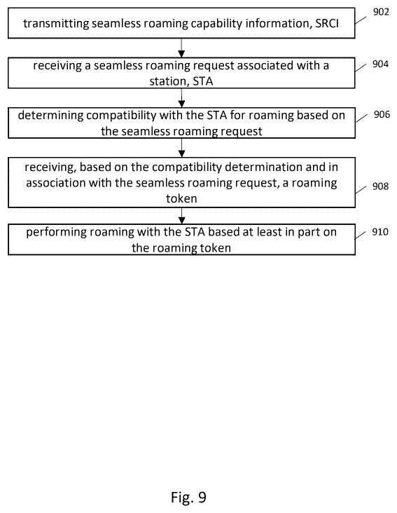

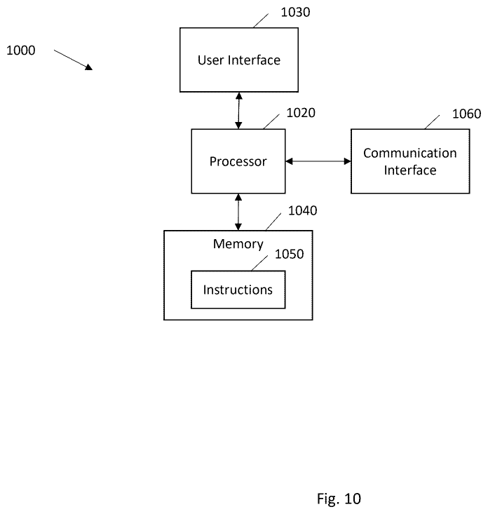

FIGS. 8 and 9 are flowcharts illustrating the operations performed in order to perform roaming in accordance with some of the embodiments disclosed herein. The flowchart of FIG. 8 illustrates the operations performed, such as by the apparatus 1000 of FIG. 10 as embodied by a STA, in order to support communications with an AP. The flowchart of FIG. 9 illustrates the operations performed, such as by the apparatus 1000 of FIG. 10 as embodied by the AP, in order to support communications with a STA.

In the example flowchart of FIG. 8, a STA (e.g., STAs 115) embodied, such as by apparatus 1000 of FIG. 10, includes means, such as the processor 1020, the communication interface 1060 or the like, for exchanging information with a first access point (AP), as shown in block 802. The information may be exchanged by the apparatus 1000 based on operations of the processor 1020 and via communications interface 1060, for example, by transmitting and/or receiving data, directly or indirectly, to and/or from the AP. The STA also includes means, such as the processor 1020, the communication interface 1060 or the like, for receiving seamless roaming capability information (SRCI) from a second AP, as shown in block 804. The SRCI may be obtained by the processor 1020 via the communication interface 1060, for example, by receiving the SRCI directly or indirectly from the second AP. The STA also includes means, such as the processor 1020, the communication interface 1060 or the like, for causing transmission of at least a seamless roaming request to the second AP in response to determining compatibility with the second AP for roaming based at least in part on the SRCI, as shown in block 806. The STA also includes means, such as the processor 1020, the communication interface 1060 or the like, for causing a roaming token to be provided to the second AP in association with the seamless roaming request, as shown in block 808. The STA also includes means, such as the processor 1020, the communication interface 1060 or the like, for causing the STA to perform roaming to the second AP based on a response received from the second AP.

In the example flowchart of FIG. 9, an AP (e.g., APs 110) which may be embodied by the apparatus 1000 of FIG. 10, includes means, such as the processor 1020, the communication interface 1060 or the like, for transmitting seamless roaming capability information (SRCI), as shown in block 902. The AP also includes means, such as the processor 1020, the communication interface 1060 or the like, for receiving a seamless roaming request associated with a station (STA), as shown in block 904. The AP also includes means, such as the processor 1020, the communication interface 1060 or the like, for determining compatibility with the STA for roaming based on the seamless roaming request, as shown in block 906. The AP also includes means, such as the processor 1020, the communication interface 1060 or the like, for receiving a roaming token based on the compatibility determination and in association with the seamless roaming request, as shown in block 906. The AP also includes means, such as the processor 1020, the communication interface 1060 or the like, for causing the AP to perform roaming with the STA based at least in part on the roaming token.

FIGS. 8 and 9 are flowcharts illustrating methods according to certain example embodiments. It will be understood that each block or signal and combination of blocks and signals may be implemented by various means, such as hardware, firmware, processor, circuitry, and/or other communication devices associated with execution of software including one or more computer program instructions. For example, one or more of the procedures described above may be embodied by instructions, such as for example computer program instructions. In this regard, the instructions which embody the procedures described above may be stored by the memory 1040 of an apparatus 1000 employing an example embodiment and executed by at least one processor 1020. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In FIG. 1, client devices 115 are configured to be in a wireless connection with at least one Wi-Fi AP (e.g., the APs 110). Functionalities of the at least one Wi-Fi AP may be implemented by various entities and/or types of entities, for example, such as APs, mAPs, access nodes, nodes, hosts, servers, base stations, and/or other entities suitable for such usage. Functionalities of the at least one client device may be implemented by various entities and/or types of entities, for example, such as clients-side user devices, non-AP STAs, user equipment (UEs), and/or other entities suitable for such usage.

In some examples, the communications system 100 may support radiofrequency sensing during IFS. In some examples, the communications system 100 may include a transceiver for transmitting and/or receiving signals. The transceiver may be implemented as a single integrated circuit (e.g., using a single application-specific integrated circuit (ASIC) or field-programmable gate array (FPGA)) or as a system-on-a-chip (SOC) that includes different modules for implementing the functionality of the transceiver. The network manager may include a processor and/or a memory (e.g., such as a processor 1020 and/or a memory 1040, further described with respect to FIG. 10). The processor 1020 may be used to execute the instructions 1050 stored in the memory 1040 and/or to store information in the memory 1040, for example, such as the results of the executed instructions.

The Wi-Fi APs 110 may include transceivers for transmitting and/or receiving signals, for example, over a backbone and/or over an access interface. A transceiver may be implemented as a single integrated circuit (e.g., using a single ASIC or FPGA) or as a SOC that includes different modules for implementing the functionality of the transceiver.

An apparatus 1000 may be implemented by a user device to which resources on the access interface are allocated and assigned, and thus any feature described herein with a user device may be implemented with a corresponding apparatus, such as the apparatus 1000. The Wi-Fi AP 110 may further include a processor (e.g., such as the processor 1020) and a memory (e.g., such as the memory 1040), such that the apparatus 1000 may also be embodied by an AP. The processor 1020 may be used to execute the instructions 1050 stored in the memory 1040 and/or to store information in the memory 1040, for example, such as the results of the executed instructions.

The apparatus 1000 may be configured to function as the cloud network 105, APs 110, client devices 115, and/or other entities. As shown in FIG. 10, the apparatus includes, is associated with, and/or is in communication with: a processor 1020, a memory 1040, and a communication interface 1060. The processor 1020 may be in communication with the memory device 1040 via a bus for passing information among components of the apparatus 1000. The memory device 1040 may be non-transitory and may include, for example, one or more volatile and/or non-volatile memories. In other words, for example, the memory device 1040 may be an electronic storage device (e.g., a computer readable storage medium) comprising gates configured to store data (e.g., bits) that may be retrievable by a machine (e.g., a computing device like the processor 1020). The memory device 1040 may be configured to store information, data, content, applications, instructions, or the like for enabling the apparatus to carry out various functions in accordance with an example embodiment of the present disclosure (e.g., the instructions 1050). For example, the memory device 1040 could be configured to buffer input data for processing by the processor 1020. Additionally or alternatively, the memory device 1040 may be configured to store the instructions 1050 for execution by the processor 1020.

The instructions 1050 may be comprised in a computer-readable medium or a non-transitory computer readable medium. A term “non-transitory”, as used herein, is a limitation of the medium itself (e.g., tangible, not a signal) as opposed to a limitation on data storage persistency (e.g., random access memory (RAM) vs. read only memory (ROM)).

FIG. 10 depicts an example of a simplified block diagram of an apparatus according to various embodiments of the present disclosure, whose implementation may differ from what is shown. The connections shown in FIG. 10 are logical connections; the actual physical connections may be different. It is apparent to a person skilled in the art that the system typically comprises also other functions and structures than those shown in FIG. 10.

The apparatus 1000 may, in some embodiments, be embodied in various computing or communication devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single system on a chip (SOC). As such, in some cases, a chip or chipset may constitute means for performing one or more operations for providing the functionalities described herein.

The processor 1020 may be embodied in a number of different ways. For example, the processor 1020 may be implemented by processing circuitry. For example, the processor 1020 may be embodied as one or more of various hardware processing means such as a coprocessor, a microprocessor, a controller, a digital signal processor (DSP), a processing element with or without an accompanying DSP, or various other circuitry including integrated circuits such as, for example, an application specific integrated circuit (ASIC), a field programmable gate array (FPGA), a microcontroller unit (MCU), a hardware accelerator, a special-purpose computer chip, and/or the like. As such, in some embodiments, the processor 1020 may include one or more processing cores configured to perform independently. A multi-core processor may enable multiprocessing within a single physical package. Additionally or alternatively, the processor 1020 may include one or more processors configured in tandem via the bus to enable independent execution of instructions, pipelining and/or multithreading.

In an example embodiment, the processor 1020 may be configured to execute the instructions 1050 stored in the memory device 1040 or otherwise accessible to the processor 1020. Alternatively or additionally, the processor 1020 may be configured to execute hard coded functionality. As such, whether configured by hardware or software methods, or by a combination thereof, the processor 1020 may represent an entity (e.g., physically embodied in circuitry) capable of performing operations according to an embodiment of the present disclosure while configured accordingly. Thus, for example, when the processor 1020 is embodied as an ASIC, FPGA, and/or the like, the processor 1020 may be specifically configured hardware for conducting the operations described herein. Alternatively or additionally, as another example, when the processor 1020 is embodied as an executor of instructions (e.g., instructions 1050), the instructions may specifically configure the processor to perform the algorithms and/or operations described herein when the instructions are executed. However, in some cases, the processor 1020 may be a processor of a specific device (e.g., an image or video processing system) configured to employ an embodiment of the present disclosure by further configuration of the processor by instructions for performing the algorithms and/or operations described herein. The processor 1020 may include, among other things, a clock, an arithmetic logic unit (ALU), and/or logic gates configured to support operation of the processor 1020.

The communication interface 1060 may be a device and/or circuitry embodied in either hardware or a combination of hardware and software that is configured to receive and/or transmit data, including media content in the form of video or image files, one or more audio tracks, and/or the like. In this regard, the communication interface 1060 may include, for example, an antenna (or multiple antennas) and supporting hardware and/or software for enabling communications with a wireless communication network. Additionally or alternatively, the communication interface 1060 may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some examples, the apparatus 1000 may be an access point (AP) or a non-AP station (STA) (e.g., such as a client device) usable in a Wi-Fi network operating in accordance with wireless standards (e.g., IEEE 802.11 standards). For example, the apparatus 1000 may be a terminal device, such as the STAs 115 of FIG. 1. As another example, the apparatus 1000 may be comprised in such a terminal device, for example, as a chipset configured to control the terminal device. As another example, the apparatus 100 may be a non-AP STA, such as the APs 110 of FIG. 1. The apparatus 1000 may be caused or configured to perform at least the method of FIGS. 8-9 and/or any one or more of the embodiments described.

In an embodiment, at least some of the processes described herein may be carried out by an apparatus comprising means for carrying out at least some of the described processes. Means for performing elements of the method as disclosed herein may include software and/or hardware components of the apparatus 1000. For example, the at least one processor 1020, the memory 1040, and the instruction 1050 form means for carrying out the method or methods as disclosed herein, and any of the embodiments thereof. As used herein the term “means” is to be construed in singular form, e.g., referring to a single element, or in plural form, e.g., referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

Even though the present disclosure has been described above with reference to an example according to the accompanying drawings, it is clear that the present disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1-26. (canceled)

27. An apparatus comprising at least one processor and at least one memory storing instructions that, when executed by the at least one processor, cause the apparatus to perform at least:
exchanging information with a first access point, AP;
receiving seamless roaming capability information, SRCI from a second AP;
in response to determining compatibility with the second AP for roaming based at least in part on the SRCI, transmitting at least a seamless roaming request to the second AP;
causing a roaming token to be provided to the second AP in association with the seamless roaming request; and
performing roaming to the second AP based on a response received from the second AP.

28. The apparatus according to claim 27, wherein the roaming token comprises one or more context transfer parameters for performing roaming to the second AP, the one or more context transfer parameters comprising at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

29. The apparatus according to claim 27, wherein the roaming token comprises a remote token identifier, the remote token identifier configured to enable the second AP to receive one or more context transfer parameters or data frames from a remote source, and wherein the remote token identifier is allocated, created, or signed by at least one of the first AP, the second AP, a seamless roaming server, SRS, or a station, STA.

30. The apparatus according to claim 29, wherein the remote source is the first AP, a third AP, a SRS, or a STA.

31. The apparatus according to claim 27, wherein the roaming token further comprises context information comprising at least one of SN or Block Ack parameters, and wherein the instructions, when executed by the at least one processor, further cause the apparatus to perform at least:
exchanging information with the second AP using at least one of the SN or Block Ack parameters.

32. The apparatus according to claim 27, wherein the SRCI comprises seamless roaming related information associated with at least one of: capability information associated with the second AP supporting roaming, current or supported multi-link devices, MLDs, or mobility domains, roaming agreements, SRS support, buffer information, a roaming token, downlink, DL, or uplink, UL, frame delivery, supported seamless roaming levels or configurations, multi-AP transmission opportunity, TXOP, sharing, or non-primary channel access, NPCA, information.

33. The apparatus according to claim 27, wherein performing roaming comprises at least one of:
receiving information about adding the second AP to a first AP MLD, adding the second AP to a first AP MLD based on received information about adding the second AP to the first AP MLD, receiving information about multi-link, ML, reconfiguration with the second AP, performing ML reconfiguration with the second AP based on received information about ML reconfiguration, adding one or more links to the second AP in a first AP MLD, adding a new link to the second AP as a second AP MLD and aggregating links in a first AP MLD and the second AP MLD, or exchanging information with the second AP using a second AP MLD.

34. The apparatus according to claim 27, wherein the first AP and the second AP are able to be placed at separate locations.

35. The apparatus according to claim 27, wherein the seamless roaming request is included in an action frame, (re)association request, multi-link-operation, MLO, update request frame, ML link reconfiguration request frame, or trigger frame.

36. The apparatus according to claim 27, wherein the instructions, when executed by the at least one processor, further cause the apparatus to perform at least:
receiving information on at least one AP candidate from the first AP, wherein compatibility with the at least one AP candidate for roaming has been confirmed by the first AP;
providing a link setup request to the first AP, the link setup request comprising information related to link addition or enablement at the at least one AP candidate; and
causing the first AP to provide one or more context transfer parameters to the at least one AP candidate.

37. The apparatus according to claim 27, wherein:
the response received from the second AP comprises NPCA control information or the response received from the second AP is an NPCA control frame comprising NPCA control information; and
performing roaming comprises:
triggering NPCA channel switching based on the received NPCA control information from the second AP; or
accessing an NPCA primary or non-primary channel based on the received NPCA control information from the second AP; or
switching between an NPCA channel with the first AP and an NPCA channel with the second AP based on the received NPCA control information from the second AP; or
switching between an NPCA primary channel with the first AP and an NPCA non-primary channel with the second AP based on the received NPCA control information from the second AP; or
switching between an NPCA non-primary channel with the first AP and a BSS primary channel with the second AP; or
simultaneously accessing an NPCA channel with the first AP and an NPCA channel with the second AP based on the received NPCA control information from the second AP; or
enabling an NPCA mode based on the received NPCA control information from the second AP.

38. The apparatus according to claim 27, wherein the instructions, when executed by the at least one processor, further cause the apparatus to perform at least:
providing roaming control parameters to the first AP or the second AP, the roaming control parameters comprising control information associated with at least one of:
an UL or DL frame delivery option associated with the roaming;
an outside the context of a BSS, OCB, data frame delivery option associated with seamless roaming;
a level of allowed sharing of context transfer parameters or data frames between network entities; or
a selected link configuration for communication with the second AP based on link configuration information included within the SRCI.

39. A method comprising:
exchanging information with a first access point, AP;
receiving seamless roaming capability information, SRCI from a second AP;
in response to determining compatibility with the second AP for roaming based at least in part on the SRCI, transmitting at least a seamless roaming request to the second AP;
causing a roaming token to be provided to the second AP in association with the seamless roaming request; and
performing roaming to the second AP based on a response received from the second AP.

40. The method according to claim 39, wherein the roaming token comprises one or more context transfer parameters for performing roaming to the second AP, the one or more context transfer parameters comprising at least one of: media access control, MAC, service data unit, MSDU, -level context data, sequence number, SN, information, block ack parameters, BA, buffer status information, authentication parameters, transmission control protocol/internet protocol, TCP/IP, session information, multipath TCP, MPTCP, information, MPTCP sequence number, MPTCP Ack status information, geographical information, a time-specific limitation or value, primary channel information, secondary channel information, target wake time, TWT, scheduling information, beamforming information, or spatial re-use information.

41. The method according to claim 39, wherein the roaming token comprises a remote token identifier, the remote token identifier configured to enable the second AP to receive one or more context transfer parameters or data frames from a remote source, and wherein the remote token identifier is allocated, created, or signed by at least one of the first AP, the second AP, a seamless roaming server, SRS, or a station, STA.

42. The method according to claim 41, wherein the remote source is the first AP, a third AP, a SRS, or a STA.

43. The method according to claim 39, wherein the roaming token further comprises context information comprising at least one of SN or Block Ack parameters, and wherein the method further comprises:
exchanging information with the second AP using at least one of the SN or Block Ack parameters.

44. The method according to claim 39, wherein the SRCI comprises seamless roaming related information associated with at least one of: capability information associated with the second AP supporting roaming, current or supported multi-link devices, MLDs, or mobility domains, roaming agreements, SRS support, buffer information, a roaming token, downlink, DL, or uplink, UL, frame delivery, supported seamless roaming levels or configurations, multi-AP transmission opportunity, TXOP, sharing, or non-primary channel access, NPCA, information.

45. An apparatus comprising at least one processor and at least one memory storing instructions that, when executed by the at least one processor, cause the apparatus to perform at least:
transmitting seamless roaming capability information, SRCI;
receiving a seamless roaming request associated with a station, STA;
determining compatibility with the STA for roaming based on the seamless roaming request;
receiving, based on the compatibility determination and in association with the seamless roaming request, a roaming token; and
performing roaming with the STA based at least in part on the roaming token.

46. A method comprising:
transmitting seamless roaming capability information, SRCI;
receiving a seamless roaming request associated with a station, STA;
determining compatibility with the STA for roaming based on the seamless roaming request;
receiving, based on the compatibility determination and in association with the seamless roaming request, a roaming token; and
performing roaming with the STA based at least in part on the roaming token.
